(19) United States
(12) Patent Application Publication
(10) Pub. No.: US 2026/0142771 A1
(43) Pub. Date: May 21, 2026

(54) CHANNEL STATE INFORMATION REFERENCE SIGNAL CONFIGURATION SIGNALING BETWEEN RADIO ACCESS NETWORK NODES

(71) Applicant: QUALCOMM Incorporated, San Diego, CA (US)

(72) Inventors: Chiranjib SAHA, Lakeside, CA (US); Andrei Dragos RADULESCU, La Jolla, CA (US); Abhishek Saurabh SACHIDANAND SINHA, San Diego, CA (US); John Wallace NASIELSKI, San Diego, CA (US)

(21) Appl. No.: 18/954,317

(22) Filed: Nov. 20, 2024

(51) Int. Cl. H04L 5/00; H04W 24/10

(52) U.S. Cl. CPC H04L 5/0048; H04W 24/10

(57) ABSTRACT

Various aspects of the present disclosure generally relate to wireless communication. In some aspects, a first radio access network (RAN) node may receive, from a second RAN node, a channel state information reference signal (CSI-RS) configuration message associated with a CSI report to be provided to the second RAN node by a user equipment (UE). The first RAN node may transmit, to the second RAN node and based at least in part on receiving the CSI-RS configuration message, a CSI-RS configuration confirmation message. Numerous other aspects are described.

### FIELD OF THE DISCLOSURE

Aspects of the present disclosure generally relate to wireless communication and specifically relate to techniques, apparatuses, and methods associated with channel state information reference signal configuration signaling between radio access network nodes.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Multiple radio access network (RAN) nodes in a wireless communication system may sometimes serve a single user equipment (UE), such as in examples involving carrier aggregation (CA). In some examples, the multiple RAN nodes being used for purposes of CA may be associated with a same vendor or different vendors. Accordingly, in order to support CA, among other operations, RAN nodes may be connected via and/or may communicate via an inter-RAN-node interface, sometimes referred to as a D2 interface. In such examples, the D2 interface may include a D2 control plane (D2-C) interface and a D2 user plane (D2-U) interface, among other examples. In some examples, the D2 interface may connect MAC layers of the RAN nodes.

In some examples, such as examples involving multiple distributed units (DUs) (as examples of multiple RAN nodes) associated with CA, a DU hosting a primary cell (PCell) may be referred to as a primary DU (P-DU), and/or a DU hosting a secondary cell (SCell) may be referred to as a secondary DU (S-DU). In such cases, a P-DU may receive downlink data from a central unit (CU) (e.g., a CU user plane (CU-UP) unit) and/or may schedule the downlink data with one or more S-DUs to transmit on SCells. In some cases, such as cases in which uplink CA is not supported, physical uplink control channel (PUCCH) communications for both the PCell and the SCells are received by the P-DU, and the P-DU may extract the relevant part of the PUCCH communications and may forward the extracted information to the S-DUs.

### SUMMARY

Some aspects described herein relate to a method of wireless communication performed by a first radio access network (RAN) node. The method may include receiving, from a second RAN node, a channel state information reference signal (CSI-RS) configuration message associated with a CSI report to be provided to the second RAN node by a user equipment (UE). The method may include transmitting, to the second RAN node and based at least in part on receiving the CSI-RS configuration message, a CSI-RS configuration confirmation message.

Some aspects described herein relate to a method of wireless communication performed by a second RAN node. The method may include transmitting, to a first RAN node, a CSI-RS configuration message associated with a CSI report to be provided to the second RAN node by a UE. The method may include receiving, from the first RAN node and based at least in part on receiving the CSI-RS configuration message, a CSI-RS configuration confirmation message.

Some aspects described herein relate to a first RAN node for wireless communication. The first RAN node may include one or more memories and one or more processors coupled to the one or more memories. The one or more processors may be configured to cause the first RAN node to receive, from a second RAN node, a CSI-RS configuration message associated with a CSI report to be provided to the second RAN node by a UE. The one or more processors may be configured to cause the first RAN node to transmit, to the second RAN node and based at least in part on receiving the CSI-RS configuration message, a CSI-RS configuration confirmation message.

Some aspects described herein relate to a second RAN node for wireless communication. The second RAN node may include one or more memories and one or more processors coupled to the one or more memories. The one or more processors may be configured to cause the second RAN node to transmit, to a first RAN node, a CSI-RS configuration message associated with a CSI report to be provided to the second RAN node by a UE). The one or more processors may be configured to receive, from the first RAN node and based at least in part on receiving the CSI-RS configuration message, a CSI-RS configuration confirmation message.

Some aspects described herein relate to a non-transitory computer-readable medium that stores a set of instructions for wireless communication by a first RAN node. The set of instructions, when executed by one or more processors of the first RAN node, may cause the first RAN node to receive, from a second RAN node, a CSI-RS configuration message associated with a CSI report to be provided to the second RAN node by a UE. The set of instructions, when executed by one or more processors of the first RAN node, may cause the first RAN node to transmit, to the second RAN node and based at least in part on receiving the CSI-RS configuration message, a CSI-RS configuration confirmation message.

Some aspects described herein relate to a non-transitory computer-readable medium that stores a set of instructions for wireless communication by a second RAN node. The set of instructions, when executed by one or more processors of the second RAN node, may cause the second RAN node to transmit, to a first RAN node, a CSI-RS configuration message associated with a CSI report to be provided to the second RAN node by a UE. The set of instructions, when executed by one or more processors of the second RAN node, may cause the second RAN node to receive, from the first RAN node and based at least in part on receiving the CSI-RS configuration message, a CSI-RS configuration confirmation message.

Some aspects described herein relate to an apparatus for wireless communication. The apparatus may include means for receiving, from a RAN node, a CSI-RS configuration message associated with a CSI report to be provided to the RAN node by a UE. The apparatus may include means for transmitting, to the RAN node and based at least in part on receiving the CSI-RS configuration message, a CSI-RS configuration confirmation message.

Some aspects described herein relate to an apparatus for wireless communication. The apparatus may include means for transmitting, to a RAN node, a CSI-RS configuration message associated with a CSI report to be provided to the apparatus by a UE. The apparatus may include means for receiving, from the RAN node and based at least in part on receiving the CSI-RS configuration message, a CSI-RS configuration confirmation message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of carrier aggregation, in accordance with the present disclosure.

FIG. 4 is a diagram illustrating examples of channel state information reference signal (CSI-RS) beam management procedures, in accordance with the present disclosure.

FIG. 5 is a diagram of an example associated with CSI-RS configuration signaling between radio access network (RAN) nodes, in accordance with the present disclosure.

FIG. 6 is a diagram illustrating an example process performed, for example, at a first RAN node or an apparatus of a first RAN node, in accordance with the present disclosure.

FIG. 7 is a diagram illustrating an example process performed, for example, at a second RAN node or an apparatus of a second RAN node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication systems, channel state information (CSI) reporting may be categorized as either aperiodic CSI reporting or periodic CSI reporting. Periodic CSI reporting is associated with an upper layer (e.g., radio resource control (RRC) layer) configuration mechanism. When configured, CSI is reported periodically for one activated component carrier (CC). Periodic CSI reports may be transmitted using a physical uplink control channel (PUCCH) or a physical uplink shared channel (PUSCH). Periodic CSI reporting may be typically used for primary cells (PCells) in examples involving carrier aggregation (CA) using multiple distributed units (DUs), and thus may be associated with a primary DU (P-DU). Aperiodic CSI reporting is associated with CSI reports that use a triggering mechanism. When triggered, CSI is either reported for all activated downlink CCs or else is reported for the downlink CC that is linked to the uplink CC for which the grant containing the trigger is transmitted. In some examples, aperiodic CSI reports may be transmitted using a PUSCH.

In some examples, a network node may configure a user equipment (UE) (e.g., using a higher layer mechanism, such as an RRC configuration message) with one or more parameters associated with aperiodic CSI reporting. Later, the network node may trigger an aperiodic CSI report, such as by using lower-layer signaling (e.g., medium access control (MAC) control element (MAC-CE) signaling and/or downlink control information (DCI), among other examples). For example, the network node may trigger the UE to generate an aperiodic CSI report in order to determine how well the UE receives a downlink signal of a serving cell. The network node may further transmit a CSI related reference signal (e.g., a CSI-RS), such as by using a time-domain resource that is a first configured offset from the lower-layer triggering message. The UE may perform measurements on the CSI-RS and/or may transmit, to the network node (e.g., using a PUSCH), a CSI report including measurement results associated with the CSI-RS. In some examples, the UE may transmit the CSI report to the network node using a time-domain resource that is a second configured offset from the lower-layer triggering message. In some examples, such as examples involving carrier aggregation, the lower-layer triggering message may indicate for which cell, of the multiple cells, the CSI report is requested.

In some cases, such as examples involving multi-vendor CA using multiple radio access network (RAN) nodes (e.g., multiple DUs), among other examples, a DU associated with a secondary cell (SCell) (e.g., a secondary DU (S-DU)) may need to trigger an aperiodic CSI report. However, in such examples, only the PCell served by the P-DU may be capable of scheduling a PUSCH that carries an aperiodic CSI report, because the UE may only have a PUCCH and PUSCH configured for the PCell (e.g., such as in examples in which uplink CA is not configured). In such cases, because there is no signaling mechanism to support a CSI report request over an inter-RAN interface (e.g., a D2 interface), the S-DU may be unable to provide a CSI report request to the P-DU and/or otherwise trigger the UE to provide an aperiodic report. Accordingly, a communication channel between the S-DU and the UE may degrade over time, resulting in increased communication errors and thus high power, computing, and network resource consumption for correcting communication errors.

Various aspects relate generally to CSI-RS configuration signaling between RAN nodes. Some aspects more specifically relate to signaling between RAN nodes (e.g., DUs) for a purpose of enabling CSI report requests to be communicated between the RAN nodes and/or for a purpose of enabling a RAN node associated with an SCell (e.g., an S-DU) to trigger a UE to provide an aperiodic CSI report. In some aspects, a first RAN node (e.g., a P-DU) may receive, from a second RAN node (e.g., via the D2 interface), a CSI-RS configuration message associated with a CSI report (e.g., an aperiodic CSI report) to be provided to the second RAN node by a UE. For example, the CSI-RS configuration message may indicate a CSI-RS resource configuration associated with the CSI report, an expected CSI report configuration, and/or an expected delay tolerance associated with the CSI report (e.g., a delay between transmission of a CSI report request message and reception of the corresponding CSI report). In response, the first RAN node (e.g., the P-DU) may transmit, to the second RAN node, a CSI-RS configuration confirmation message. For example, the CSI-RS configuration confirmation message may indicate a final CSI report configuration for the CSI report. Based at least in part on the CSI report configuration, the second RAN node (e.g., the S-DU) may subsequently trigger a CSI report, such as by transmitting, to the first RAN node, a CSI report request. The first RAN node may trigger the UE to provide a CSI report and/or may forward a received CSI report to the second RAN node.

Particular aspects of the subject matter described in this disclosure can be implemented to realize one or more of the following potential advantages. In some examples, by enabling CSI configuration signaling between RAN nodes (e.g., DUs), the aspects described herein can be used to increase transparency between RAN nodes associated with a coordinated CA operation, thereby improving CA communications and/or resulting in more efficient use of network resources. In some examples, by enabling a RAN node associated with an SCell (e.g., an S-DU) to request and/or receive CSI reports, such as aperiodic CSI reports, aspects described herein may result in improved communication channels between S-DUs and UEs, resulting in decreased communication errors and thus reduced power, computing, and network resource consumption otherwise required for correcting communication errors, and overall more efficient wireless communication systems.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

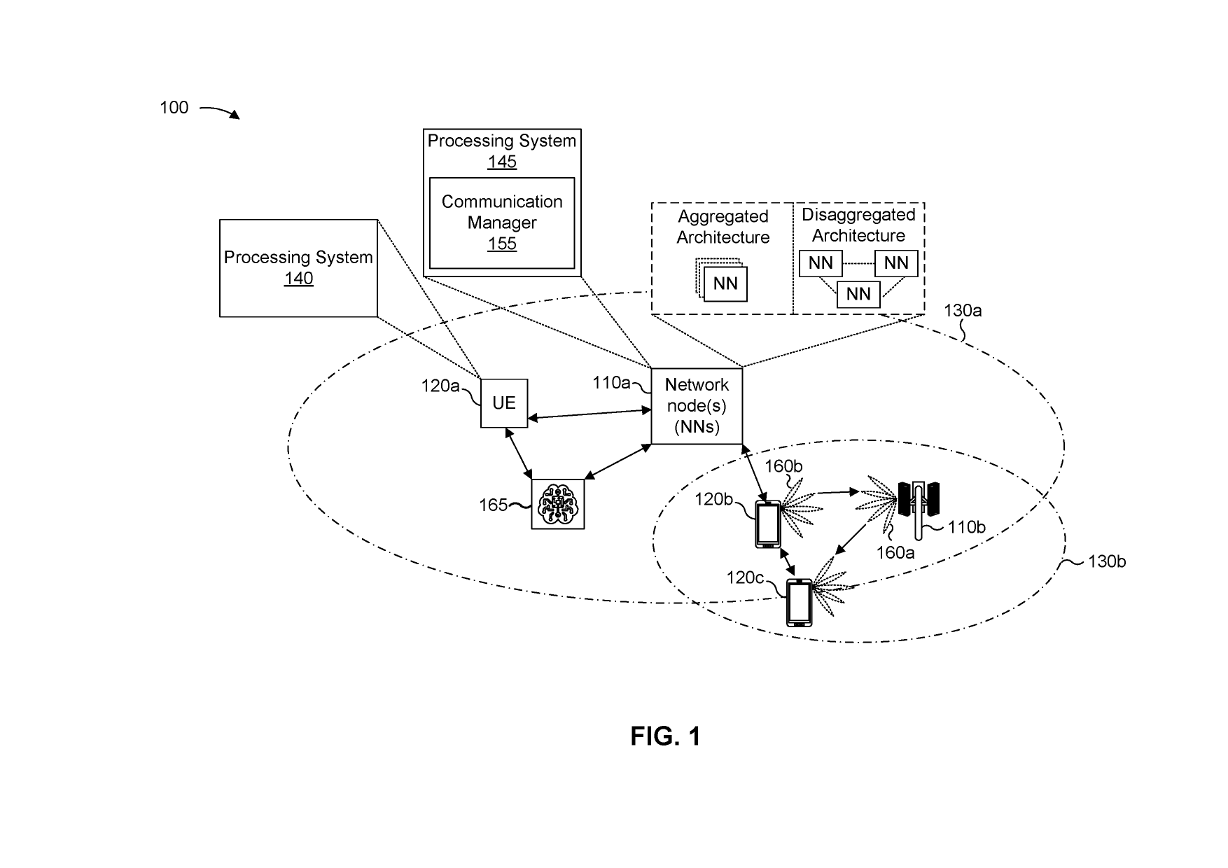

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

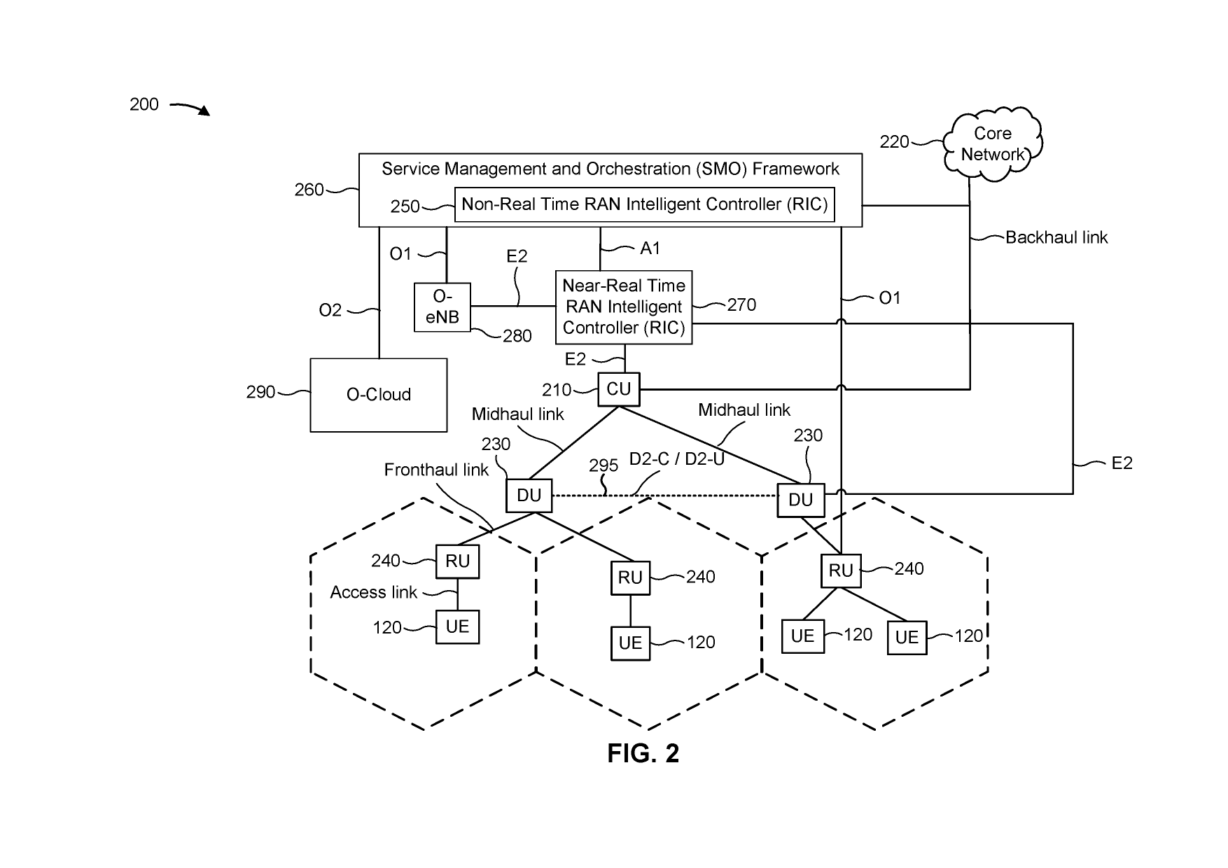

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more DUs, and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some examples, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

An anchor network node 110 may include a CU, which may perform access node controller (ANC) functions and/or AMF functions. The CU may configure a DU of the anchor network node 110 and/or may configure one or more non-anchor network nodes 110 (for example, a mobile termination (MT) function and/or a DU function of each of the IAB nodes) that connect to the core network via the anchor network node 110. Thus, a CU of an anchor network node 110 may control and/or configure the entire IAB network (or a portion thereof) that connects to the core network via the anchor network node 110, such as by using control messages and/or configuration messages (for example, an RRC configuration message or an F1 application protocol (F1AP) message).

A non-anchor network node 110 other than an anchor network node also may control and/or schedule communications for a second IAB node (for example, when the non-anchor network node provides DU functions for the MT functions of the second IAB node). In such deployments, the first non-anchor network node 110 may be referred to as a parent IAB node of the second non-anchor network node 110, and the second non-anchor network node 110 may be referred to as a child IAB node of the first non-anchor network node 110. Similarly, a child IAB node of the second non-anchor network node 110 may be referred to as a grandchild IAB node of the first non-anchor network node 110. A DU function of a parent IAB node may control and/or schedule communications for child IAB nodes of the parent IAB node. In some examples, a DU function may exercise limited control over communications of a grandchild node, such as via indication of soft resources or restricted beams at a child node associated with the grandchild node. In some examples, a non-anchor network node 110 that implements a DU function may be referred to as a scheduling node or a scheduling component, and a non-anchor network node 110 that implements an MT function may be referred to as a scheduled node or a scheduled component.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240 and/or DUs 230.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

In some aspects, multiple DUs 230 (sometimes referred to herein as RAN nodes) may serve a single UE 120, such as in examples involving CA. For example, in a case in which a product and/or server corresponding to a DU 230 is not capable of being upgraded to support a new band and/or capability (e.g., due to hardware or software limitations), among other examples, CA may be achieved by installing a new DU 230 with the required capability and/or to increase capacity. In some examples, multiple DUs 230 being used for purposes of CA may be associated with a same vendor or different vendors. Accordingly, in order to support CA, among other operations, DUs 230 may be connected via and/or may communicate via an inter-RAN-node interface, sometimes referred to as a D2 interface, as indicated by reference number 295. In such examples, the D2 interface may include a D2 control plane (D2-C) interface and a D2 user plane (D2-U) interface, among other examples. Additionally, or alternatively, the D2 interface may connect MAC layers of the DUs 230.

In some examples, an SMO may configure DUs 230 to use the D2 interface, such as by using an O1 interface. For example, the O1 interface may be used by the SMO to indicate, to the DUs 230, information such as Internet protocol (IP) addresses of the DUs 230, cell radio network temporary identifiers (C-RNTIs) of the DUs 230, physical channel identities (PCIs) associated with the DUs 230, and/or similar information that may be needed for functioning of the D2 interface. In some examples, the D2 interface may be configured automatically based on self-detection of DUs 230 supporting cells that can be aggregated.

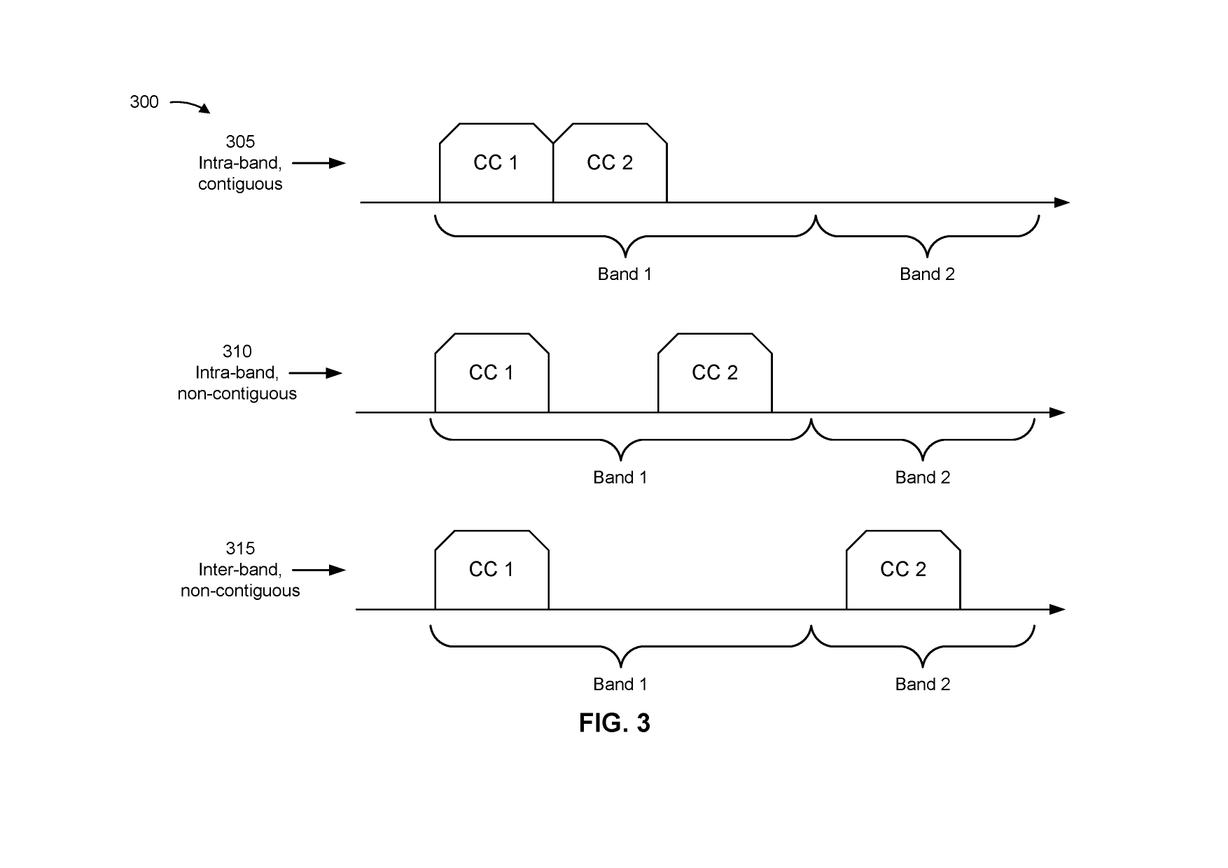

In some examples, such as examples involving multiple DUs 230 associated with CA, a DU 230 hosting a PCell may be referred to as a P-DU, and/or a DU 230 hosting an SCell may be referred to as an S-DU. In such cases, a P-DU may receive downlink data from a CU-UP and/or may schedule the downlink data with one or more S-DUs to transmit on SCells. In some cases, such as cases in which uplink CA is not supported, PUCCH communications for both the PCell and the SCells are received by the P-DU, and the P-DU may extract the relevant part of the PUCCH communication (e.g., CQI, HARQ feedback, and/or similar information) and may forward the extracted information to the S-DUs. Examples associated with CA using multiple DUs and/or by using the D2 interface are described in more detail below in connection with FIG. 3.

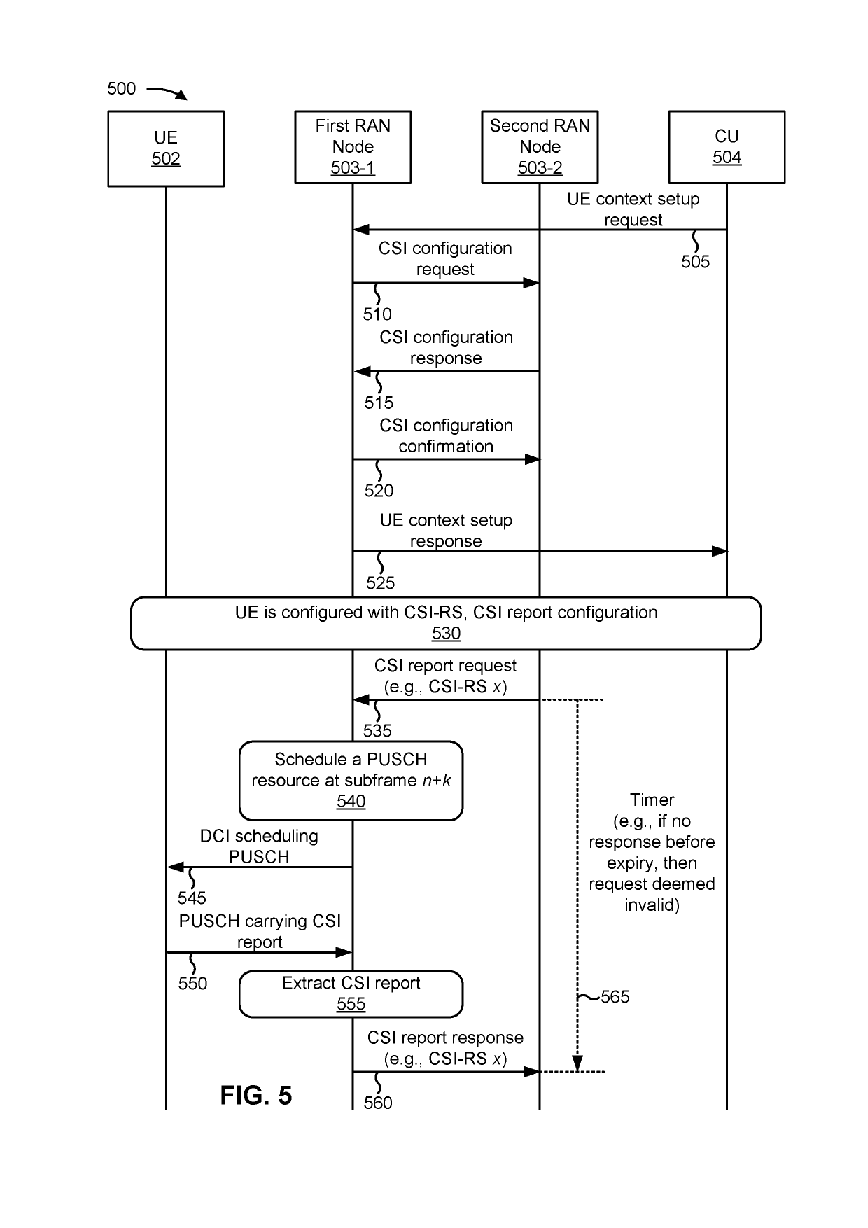

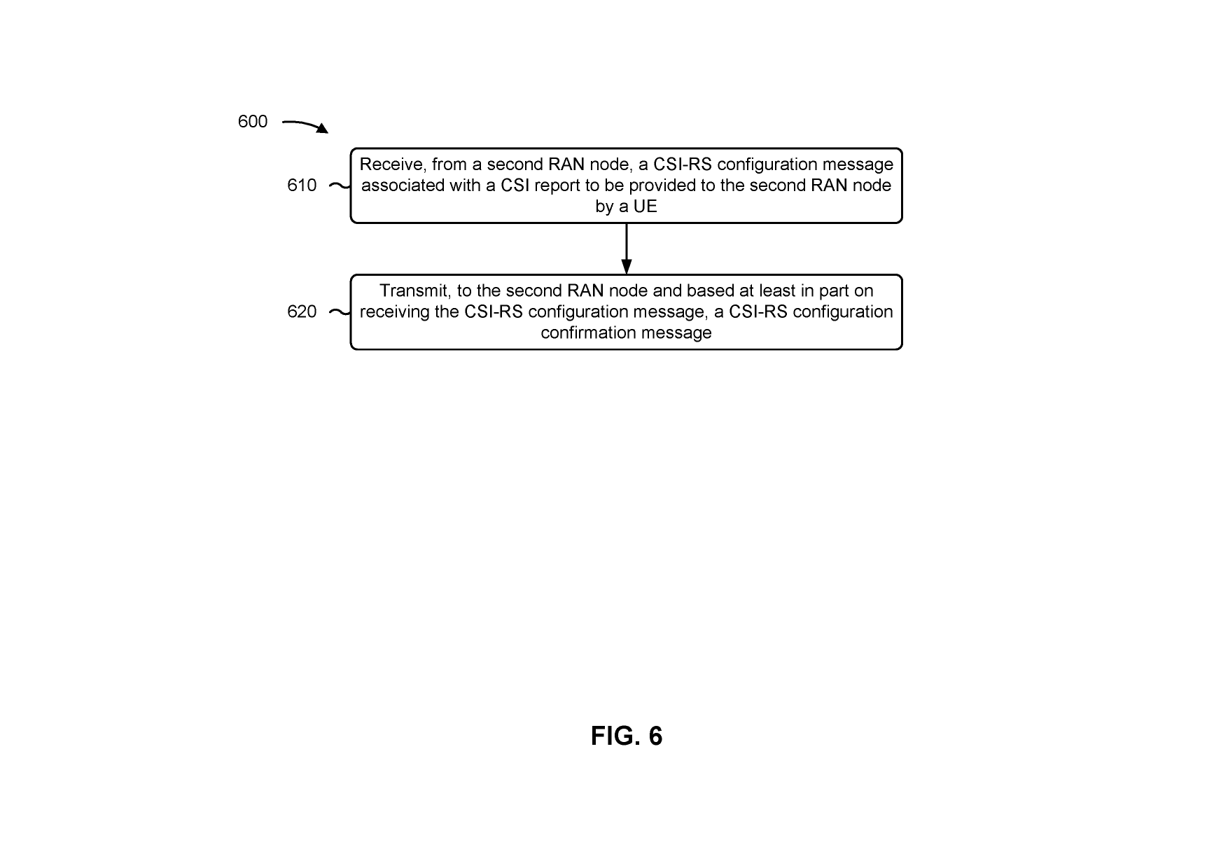

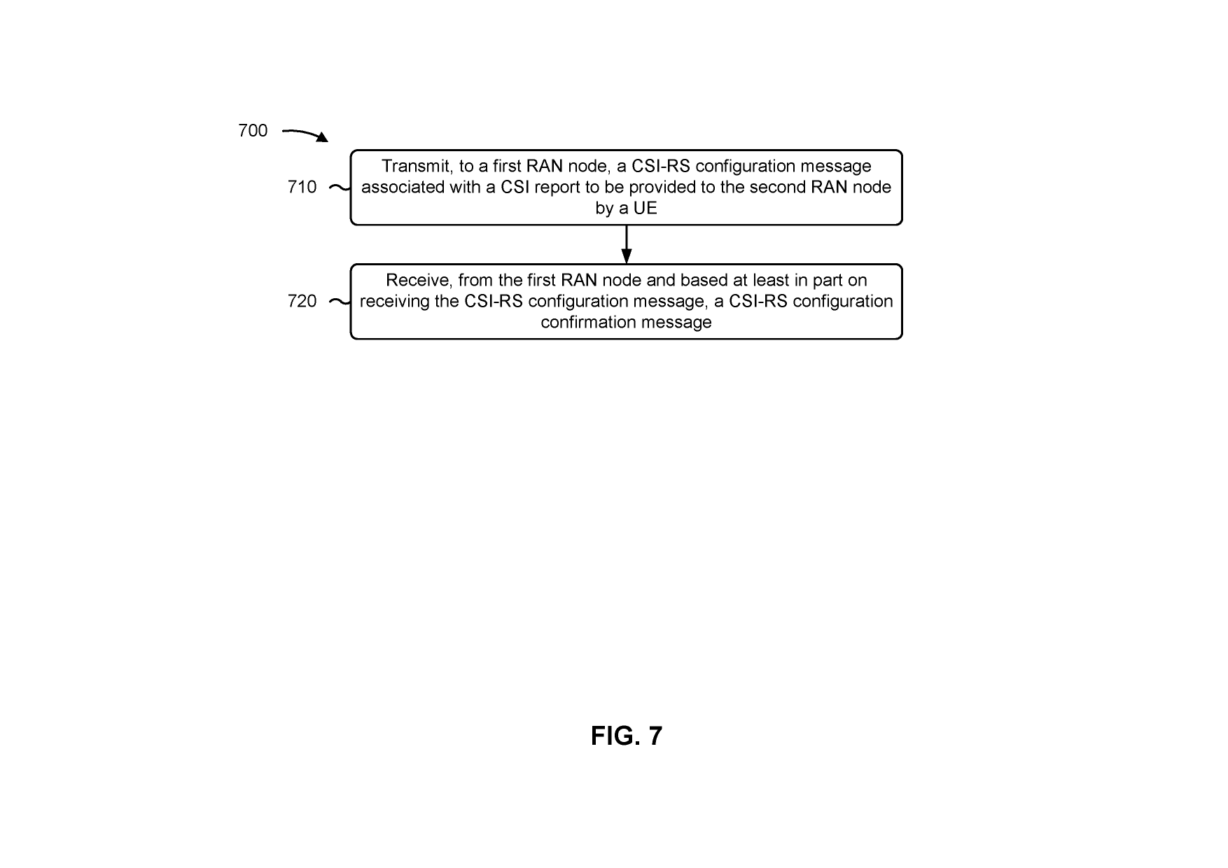

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with CSI-RS configuration signaling between RAN nodes (e.g., between DUs 230 using the D2 interface, among other examples), as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). In some aspects, the first RAN node (e.g., first RAN node 503-1 described below in connection with FIG. 5) and/or the second RAN node (e.g., second RAN node 503-2 described below in connection with FIG. 5) described herein is the network node 110, is included in the network node 110, or includes one or more components of the network node 110 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

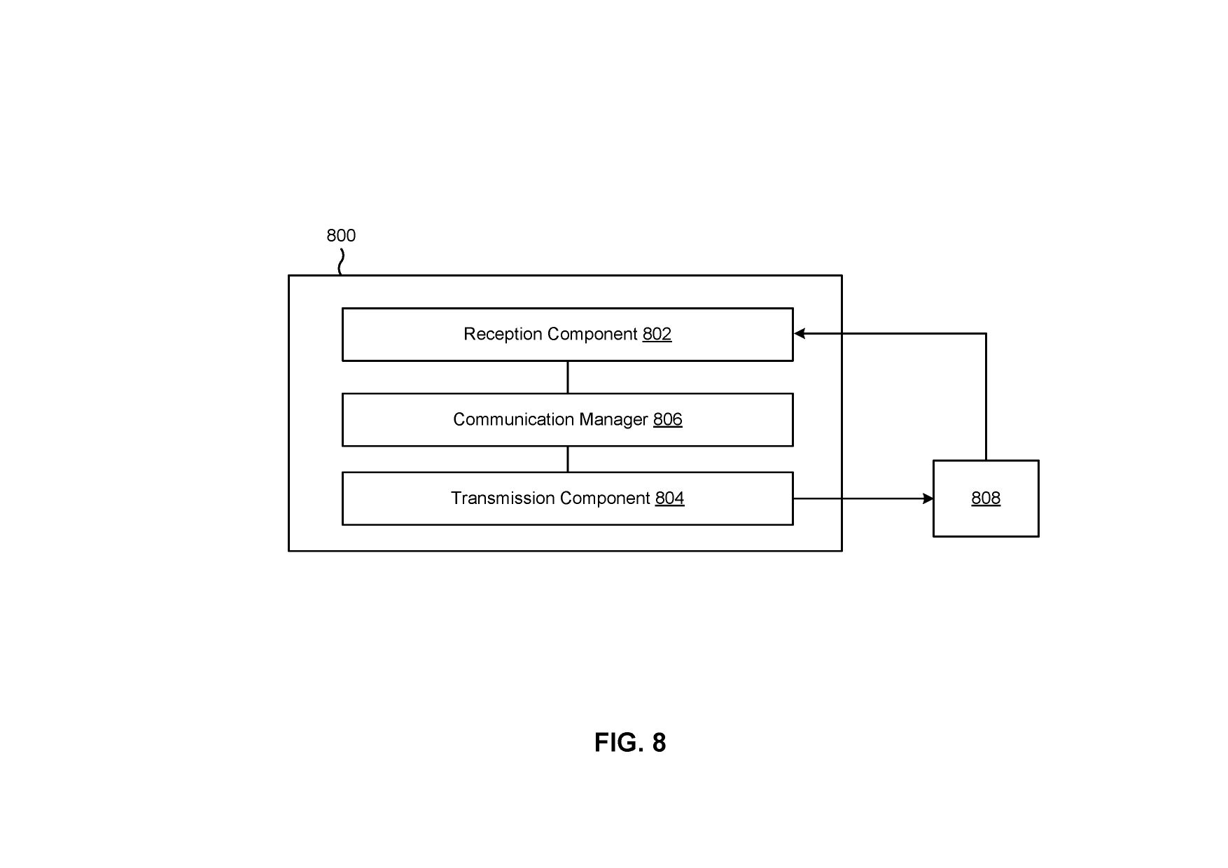

In some aspects, the first RAN node (e.g., network node 110 and/or first RAN node 503-1) includes means for receiving, from a second RAN node, a CSI-RS configuration message associated with a CSI report to be provided to the second RAN node by a UE; and/or means for transmitting, to the second RAN node and based at least in part on receiving the CSI-RS configuration message, a CSI-RS configuration confirmation message. In some aspects, the means for the first RAN node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

In some aspects, the second RAN node (e.g., network node 110 and/or second RAN node 503-2) includes means for transmitting, to a first RAN node, a CSI-RS configuration message associated with a CSI report to be provided to the second RAN node by a UE; and/or means for receiving, from the first RAN node and based at least in part on receiving the CSI-RS configuration message, a CSI-RS configuration confirmation message. In some aspects, the means for the second RAN node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

FIG. 3 is a diagram illustrating examples 300 of CA, in accordance with the present disclosure.

CA is a technology that enables two or more CCs (sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure CA for a UE 120, such as in an RRC message, DCI, and/or another signaling message.

As shown by reference number 305, in some aspects, CA may be configured in an intra-band contiguous mode where the aggregated carriers are contiguous to one another and are in the same band. As shown by reference number 310, in some aspects, CA may be configured in an intra-band non-contiguous mode where the aggregated carriers are non-contiguous to one another and are in the same band. As shown by reference number 315, in some aspects, CA may be configured in an inter-band non-contiguous mode where the aggregated carriers are non-contiguous to one another and are in different bands.

In CA, a UE 120 may be configured with a primary carrier or PCell and one or more secondary carriers or SCells. In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling. In some examples, CA may be associated with multiple DUs (e.g., DUs 230), and/or a P-DU may be associated with the PCell and one or more S-DUs may be associated with one or more SCells. In such examples, the P-DU may be connected to the S-DUs and/or the P-DU may communicate with the S-DUs via an inter-RAN interface, such as the D2 interface described above in connection with FIG. 2.

As indicated above, FIG. 3 is provided as an example. Other examples may differ from what is described with regard to FIG. 3.

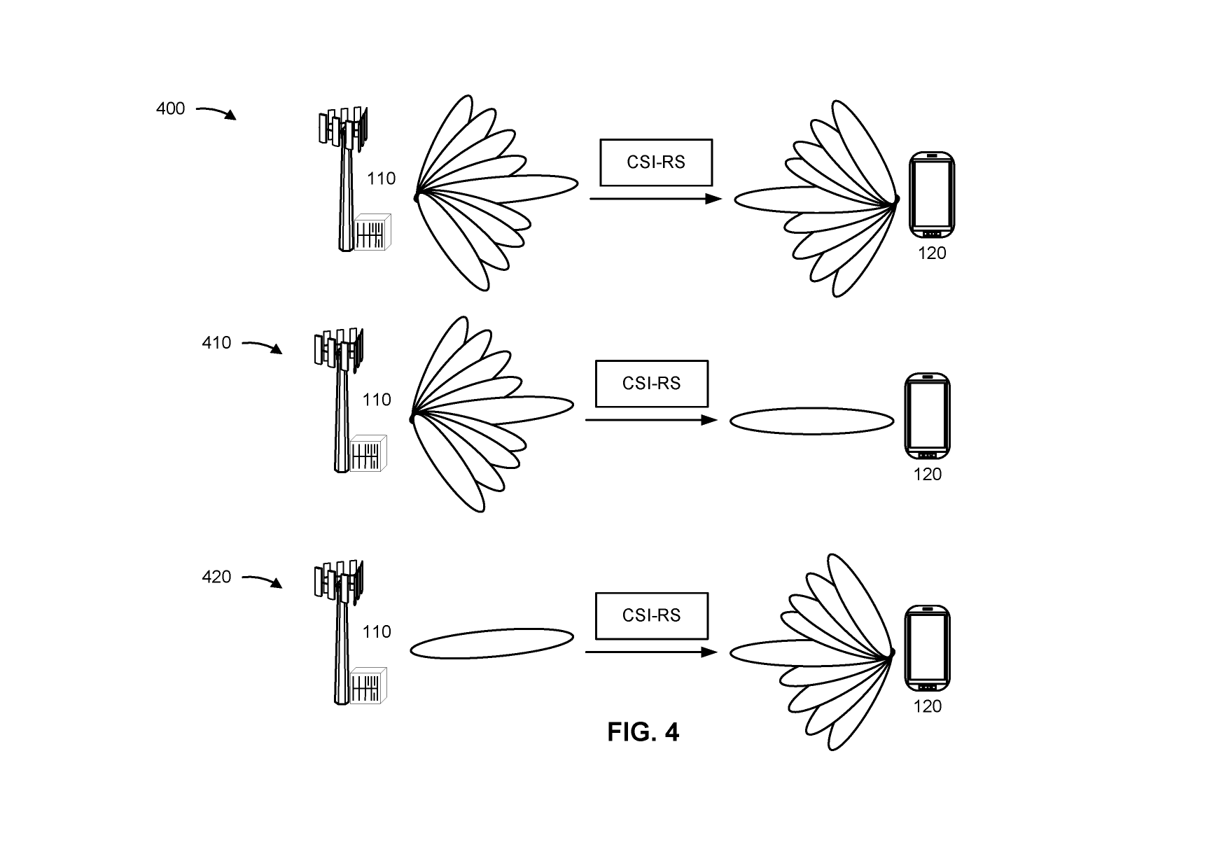

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use SSBs for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

The beam management procedures described above are only examples. Other examples may differ from the beam management procedures described above. For example, the UE 120 and the network node 110 may perform the third beam management procedure before performing the second beam management procedure, and/or the UE 120 and the network node 110 may perform a similar beam management procedure to select a UE transmit beam. Additionally, or alternatively, the UE 120 may perform CSI-RS measurements for purposes other than for the beam management procedures described above, and/or the UE 120 may be configured to report CSI measurement results periodically or aperiodically, among other examples.

More particularly, in some wireless communication systems, CSI reporting may be categorized as either aperiodic CSI reporting or periodic CSI reporting. Periodic CSI reporting is associated with an upper layer (e.g., RRC layer) configuration mechanism. When configured, CSI is reported periodically for one activated CC. Periodic CSI reports may be transmitted using a PUCCH or a PUSCH. Aperiodic CSI reporting is associated with CSI reports that use a triggering mechanism. When triggered, CSI is reported for all activated downlink CCs, is reported for the downlink CC that is linked to the uplink CC for which the grant containing the trigger is transmitted, or is reported for a subset of downlink CCs indicated by the triggering mechanism (e.g., a DCI message). In some examples, aperiodic CSI reports may be transmitted using a PUSCH.

In some examples, a network node 110 may configure a UE 120 (e.g., using a higher layer mechanism, such as an RRC configuration message) with one or more parameters associated with aperiodic CSI reporting. Later, the network node 110 may trigger an aperiodic CSI report, such as by using lower-layer signaling (e.g., MAC-CE signaling and/or DCI, among other examples). For example, the network node 110 may trigger the UE 120 to generate an aperiodic CSI report in order to determine how well the UE 120 receives a downlink signal of a serving cell. The network node 110 may further transmit a CSI related reference signal (e.g., a CSI-RS), such as by using a time-domain resource that is a first configured offset from the lower-layer triggering message (e.g., a slot that occurs X slots after the lower-layer triggering message). The UE 120 may perform measurements on the CSI-RS and/or may transmit, to the network node 110 (e.g., using a PUSCH), a CSI report including measurement results associated with the CSI-RS (e.g., CQI, RI, and/or PMI characteristics of the cell, among other examples). In some examples, the UE 120 may transmit the CSI report to the network node 110 using a time-domain resource that is a second configured offset from the lower-layer triggering message (e.g., a slot that occurs Y slots after the lower-layer triggering message). In some examples, such as examples involving CA, the lower-layer triggering message may indicate for which cell, of the multiple cells, the CSI report is requested. For example, a “CSI-request field” in DCI may be used to indicate for which cell the CSI report is requested.

Additionally, or alternatively, in some examples, the network node 110 may trigger the UE 120 to generate an aperiodic CSI report using a DCI 1_0 CSI request field. The DCI 1_0 CSI request field may indicate an index of an aperiodic trigger state configured via RRC signaling (e.g., via a CSI-AperiodicTriggerStateList (IE)) or else a codepoint associated with an aperiodic trigger state defined in a MAC-CE (e.g., an aperiodic CSI trigger state subselection MAC-CE). More particularly, a bit length of the DCI 1_0 CSI request field may be set by higher layer signaling, such as via a CSI measurement configuration IE (sometimes referred to as CSI-MeasConfig), such as via a report trigger size field (sometimes referred to as reportTriggerSize) of CSI-MeasConfig. If a bit length of DCI 1_0 CSI request field is set large enough such that the field can point to all the items of CSI-AperiodicTriggerStateList, the DCI 1_0 CSI request field directly indicates the item in the CSI-AperiodicTriggerStateList (e.g., the DCI 1_0 CSI request field directly indicates an index of an aperiodic trigger state that is being triggered by the DCI message). However, if the bit length is not set large enough such that the field can point to all the items of CSI-AperiodicTriggerStateList, the DCI 1_0 CSI request field points to the codepoint index in the MAC-CE that defines a subset of CSI-AperiodicTriggerStateList (e.g., the aperiodic CSI trigger state subselection MAC-CE, described above).

In some cases, such as examples involving multi-vendor CA using multiple DUs (e.g., DUs 230), among other examples, a DU associated with an SCell (e.g., an S-DU) may need to trigger an aperiodic CSI report. However, in such examples, only the PCell served by the P-DU may be capable of scheduling a PUSCH that carries an aperiodic CSI report, because the UE 120 may only have a PUCCH and PUSCH configured for the PCell (e.g., such as in examples in which uplink CA is not configured). In such cases, because there is no signaling mechanism to support a CSI report request over an inter-RAN interface (e.g., the D2 interface described above), the S-DU may be unable to provide a CSI report request to the P-DU and/or otherwise trigger the UE 120 to provide an aperiodic report. Accordingly, a communication channel between the S-DU and the UE 120 may degrade over time, resulting in increased communication errors and thus high power, computing, and network resource consumption for correcting communication errors.

Some techniques described herein enable signaling between RAN nodes (e.g., DUs) for a purpose of enabling CSI report requests to be communicated between the RAN nodes and/or for a purpose of enabling a RAN node associated with an SCell (e.g., an S-DU) to trigger a UE 120 to provide an aperiodic CSI report. In some aspects, a first RAN node (e.g., a P-DU) may receive, from a second RAN node (e.g., via the D2 interface), a CSI-RS configuration message associated with a CSI report (e.g., an aperiodic CSI report) to be provided to the second RAN node by a UE. For example, the CSI-RS configuration message may indicate a CSI-RS resource configuration associated with the CSI report, an expected CSI report configuration, and/or an expected delay tolerance associated with the CSI report (e.g., a delay between transmission of a CSI report request message and reception of the corresponding CSI report). In response, the first RAN node (e.g., the P-DU) may transmit, to the second RAN node, a CSI-RS configuration confirmation message. For example, the CSI-RS configuration confirmation message may indicate a final CSI report configuration for the CSI report. Based at least in part on the CSI report configuration, the second RAN node (e.g., the S-DU) may subsequently trigger a CSI report, such as by transmitting, to the first RAN node, a CSI report request. The first RAN node may trigger the UE to provide a CSI report and/or may forward a received CSI report to the second RAN node. As a result, the techniques described herein may result in improved transparency between multiple DUs associated with a CA operation and/or improved communication channels between S-DUs and UEs, resulting in decreased communication errors and thus reduced power, computing, and network resource consumption otherwise required for correcting communication errors, and overall more efficient wireless communication systems.

As indicated above, FIG. 4 is provided as an example. Other examples may differ from what is described with respect to FIG. 4.

FIG. 5 is a diagram of an example 500 associated with CSI-RS configuration signaling between RAN nodes, in accordance with the present disclosure. As shown in FIG. 5, a UE 502 (e.g., UE 120), a first RAN node 503-1 (e.g., network node 110, DU 230, and/or P-DU), a second RAN node 503-2 (e.g., network node 110, DU 230, and/or S-DU), and/or a CU 504 (e.g., network node 110, CU 210, and/or CU-CP) may communicate with one another. In some aspects, the UE 502, the first RAN node 503-1, the second RAN node 503-2, and/or the CU 504 may be part of a wireless network (e.g., wireless communication network 100). The UE 502, the first RAN node 503-1, the second RAN node 503-2, and/or the CU 504 may have established a wireless connection prior to operations shown in FIG. 5.

In some aspects, the UE 502, the first RAN node 503-1, the second RAN node 503-2, and/or the CU 504 may be capable of communicating using CA. For example, the first RAN node 503-1 and the second RAN node 503-2 may be capable of serving the UE 502 using CA (e.g., the first RAN node 503-1 may be associated with a PCell and/or may be a P-DU, and/or the second RAN node 503-2 may be associated with an SCell and/or may be an S-DU). Additionally, or alternatively, the first RAN node 503-1 and the second RAN node 503-2 may be capable of communicating with each other using an inter-RAN-node interface, such as the D2 interface (e.g., the D2-U interface and/or the D2-C interface) described above in connection with FIG. 2.

As shown by reference number 505, the CU 504 may transmit (e.g., using an F1 interface), and the first RAN node 503-1 may receive, a UE context setup request message. The UE context setup request message may be a message transmitted by the CU 504 to the first RAN node 503-1 to establish communication resources for the UE 502. In some aspects, the UE context setup request message may include information such as the UE 502’s identity, security parameters associated with the UE 502, quality of service (QoS) parameters associated with the UE 502, and/or similar information.

As shown by reference number 510, based at least in part on receiving the UE context setup request message or otherwise, the first RAN node 503-1 may transmit (e.g., over an inter-RAN-node interface, such as the D2-C interface), and the second RAN node 503-2 may receive, a CSI-RS configuration request message. In some aspects, the CSI-RS configuration request message may be a message requesting that the second RAN node 503-2 transmit a proposed CSI report configuration for one or more aperiodic (AP) CSI reports to be transmitted by the UE 502 to the second RAN node 503-2. In that regard, the CSI-RS configuration request message may sometimes be referred to herein as an AP CSI-RS report configuration request message.

As indicated by reference number 515, the second RAN node 503-2 may transmit (e.g., over an inter-RAN-node interface, such as the D2-C interface), and the first RAN node 503-1 may receive, a CSI-RS configuration message associated with one or more CSI reports to be provided to the second RAN node 503-2 by the UE 502. In some aspects, such as aspects in which the CSI-RS configuration message is associated with one or more aperiodic CSI reports, the CSI-RS configuration message may be referred to as an AP CSI-RS report configuration message. Moreover, in some aspects, the second RAN node 503-2 may transmit the CSI-RS configuration message in response to receiving the CSI-RS configuration request message described above in connection with reference number 510. In such aspects, the CSI-RS configuration message may be referred to as a CSI-RS configuration response message and/or an AP CSI-RS report configuration response message.

In some aspects, the CSI-RS configuration message may indicate proposed configuration parameters associated with one or more CSI reports (e.g., aperiodic CSI reports) to be provided to the second RAN node 503-2 by the UE 502. In that regard, the CSI-RS configuration message may indicate a CSI-RS resource configuration (e.g., a configuration associated with one or more CSI-RSs to be received and/or measured by the UE 502), an expected CSI report configuration, and/or an expected delay tolerance associated with the CSI report. In some aspects, the expected CSI report configuration may indicate an expected CSI reporting type (sometimes referred to as reportConfigType and/or which may indicate whether the CSI report configuration is associated with periodic reporting, aperiodic reporting, semi-persistent reporting on PUCCH, semi-persistent reporting on PUSCH, and/or the like), an expected report quantity (sometimes referred to as reportQuantity, which may indicate what is to be measured by the UE 502, such as one or more CQI measurements, one or more RSRP measurements, one or more signal-to-inference-plus-noise ratio (SINR) measurements, and/or similar measurements), an expected report frequency (sometimes referred to as reportFreqConfiguraiton, which may indicate a reporting granularity in the frequency domain), an expected codebook configuration (sometimes referred to as codebookConfig, which may configure parameters for a type 1 codebook and/or a type 2 codebook), and/or similar expected configuration parameters. Additionally, or alternatively, the expected delay tolerance associated with the CSI report may indicate an expected delay between issuing a CSI report request to the first RAN node 503-1 (described in more detail below in connection with reference number 535) and receiving a corresponding CSI report from the first RAN node 503-1 (described in more detail below in connection with reference number 560).

As indicated by reference number 520, the first RAN node 503-1 may transmit (e.g., over an inter-RAN-node interface, such as the D2-C interface), and the second RAN node 503-2 may receive, a CSI-RS configuration confirmation message. Put another way, based at least in part on receiving the CSI configuration message described above in connection with reference number 515, the first RAN node 503-1 may transmit, to the second RAN node 503-2, a CSI configuration confirmation message. In some aspects, such as aspects in which the CSI-RS configuration message is associated with one or more aperiodic CSI reports, the CSI-RS configuration conformation message may be referred to herein as an AP CSI-RS report configuration confirmation message.

In some aspects, the CSI-RS configuration confirmation message indicates a CSI report configuration associated with the one or more CSI reports to be provided to the second RAN node 503-2 by the UE 120, which may be the same as the expected CSI report configuration signaled to the first RAN node 503-1 by the second RAN node 503-2 (as described above in connection with reference number 515) or which may differ from the expected CSI report configuration. Put another way, the first RAN node 503-1 may select a final CSI report configuration to be used for the one or more CSI reports (e.g., one or more aperiodic CSI reports) to be provided to the second RAN node 503-2 by the UE 502, and thus may signal the final CSI report configuration to the second RAN node 503-2. In that regard, the CSI report configuration included in the CSI configuration confirmation message may indicate an identifier (ID) associated with the final CSI report configuration (sometimes referred to as reportConfigID), a carrier ID associated with the final CSI report configuration, a CSI reporting type associated with the final CSI report configuration (e.g., reportConfigType indicating whether the final CSI report configuration is associated with periodic reporting, aperiodic reporting, semi-persistent reporting on PUCCH, semi-persistent reporting on PUSCH, and/or the like), a report quantity associated with the final CSI report configuration (e.g., reportQuantity indicating what is to be measured by the UE 502, such as one or more CQI measurements, one or more RSRP measurements, one or more SINR measurements, and/or similar measurements), a report frequency associated with the final CSI report configuration (e.g., reportFreqConfiguraiton indicating a reporting granularity in the frequency domain), a codebook configuration associated with the final CSI report configuration (e.g., codebookConfig configuring parameters for a type 1 codebook and/or a type 2 codebook), and/or similar configuration parameters associated with the final CSI report configuration.

In some aspects, the first RAN node 503-1 may forward the final CSI report configuration to the CU 504 (e.g., a CU-CP), such as over the F1 interface (e.g., using a DU to CU RRC information element (IE), or similar signaling). For example, as indicated by reference number 525, the first RAN node 503-1 may transmit (e.g., using an F1 interface), and the CU 504 may receive, a UE context setup response message that indicates the final CSI report configuration, among other information. More particularly, the UE context setup response message may be a message transmitted by the first RAN node 503-1 to the CU 504 to confirm whether resources and context for the UE 502 were successfully established. In some aspects, the UE context response message may include the UE context setup result and/or details such as resource configurations and/or QoS configurations, among other examples. In such aspects, the UE context response message may indicate the final CSI report configuration. Additionally, or alternatively, the first RAN node 503-1 may transmit, and the CU 504 may receive, a UE context modification required message indicating the final CSI report configuration. For example, the first RAN node 503-1 may indicate the final CSI configuration (e.g., updated RRC parameters) to the CU 504 using a “DU to CU RRC Information” field of a UE context modification required message. Moreover, the CU 504 may be provided with the final CSI report configuration so that the UE 502 may be configured to monitor CSI-RSs associated with the second RAN node 503-2 and/or provide one or more CSI reports (e.g., aperiodic CSI reports) to the second RAN node 503-2, among other actions. Put another way, upon receiving the final CSI report configuration over the F1 interface (e.g., via an RRC container over the F1 interface, among other examples), the CU 504 may pass the final CSI report configuration to the UE 502 (e.g., via one of the first RAN node 503-1, the second RAN node 503-2, and/or another RAN node in communication with the UE 502).

More particularly, as shown by reference number 530, the CU 504, first RAN node 503-1, and/or second RAN node 503-2 may transmit, and the UE 502 may receive, configuration information. In some aspects, the UE 502 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may be used to select a candidate configuration and/or communication parameter from the one or more candidate configurations and/or communication parameters. In some aspects, the subsequent indication (e.g., an indication described herein, such as an indication associated with the communication described below in connection with reference number 545) may include a dynamic indication, such as one or more MAC-CEs and/or one or more DCI messages, among other examples.

In some aspects, the configuration information may indicate one or more CSI-RSs to be monitored and/or measured by the UE 502. For example, the configuration information may indicate one or more CSI-RSs to be transmitted by the second RAN node 503-2 and/or measured by the UE 502. Additionally, or alternatively, the configuration information may indicate the final CSI report configuration to be used to provide measurement results (e.g., one or more aperiodic CSI reports) to the second RAN node 503-2. In this regard, and as described above in connection with reference number 520, the configuration information may indicate an ID associated with the CSI report configuration (e.g., reportConfigID), a carrier ID associated with the CSI report configuration, a CSI reporting type associated with the CSI report configuration (e.g., reportConfigType indicating whether the final CSI report configuration is associated with periodic reporting, aperiodic reporting, semi-persistent reporting on PUCCH, semi-persistent reporting on PUSCH, and/or the like), a report quantity associated with the CSI report configuration (e.g., reportQuantity indicating what is to be measured by the UE 502, such as one or more CQI measurements, one or more RSRP measurements, one or more SINR measurements, and/or similar measurements), a report frequency associated with the CSI report configuration (e.g., reportFreqConfiguraiton indicating a reporting granularity in the frequency domain), a codebook configuration associated with the CSI report configuration (e.g., codebookConfig configuring parameters for a type 1 codebook and/or a type 2 codebook), and/or similar configuration parameters.

The UE 502 may configure itself based at least in part on the configuration information. In some aspects, the UE 502 may be configured to perform one or more operations described herein based at least in part on the configuration information.

In some aspects, the UE 502 may transmit, and the first RAN node 503-1, the second RAN node 503-2, and/or the CU 504 (e.g., via the first RAN node 503-1 and/or the second RAN node 503-2) may receive, a capabilities report (not shown). The capabilities report may indicate whether the UE 502 supports a feature and/or one or more parameters related to the feature. For example, the capabilities report may indicate a capability and/or parameter for supporting CA using multiple RAN nodes (e.g., multiple DUs). As another example, the capabilities report may indicate a capability and/or parameter for performing CSI measurements and/or reporting while performing CA using multiple RAN nodes. One or more operations described herein may be based on capability information of the capabilities report. For example, the UE 502 may perform a communication in accordance with the capability information, or may receive configuration information that is in accordance with the capability information.

In some aspects, the configuration information described in connection with reference number 530 and/or the capabilities report may include information transmitted via multiple communications. Additionally, or alternatively, the first RAN node 503-1, the second RAN node 503-2, and/or the CU 504 (e.g., via the first RAN node 503-1 and/or the second RAN node 503-2) may transmit the configuration information, or a communication including at least a portion of the configuration information, before and/or after the UE 502 transmits the capabilities report. For example, the first RAN node 503-1, the second RAN node 503-2, and/or the CU 504 may transmit a first portion of the configuration information before the capabilities report, the UE 502 may transmit at least a portion of the capabilities report, and the first RAN node 503-1, the second RAN node 503-2, and/or the CU 504 may transmit a second portion of the configuration information after receiving the capabilities report.

As indicated by reference number 535, the second RAN node 503-2 may transmit, and the first RAN node 503-1 may receive, a CSI report request associated with the UE 502. In some aspects, the CSI report request may be used to request that one or more aperiodic CSI reports be prepared by the UE 502 and provided the second RAN node 503-2 (via the first RAN node 503-1, as described in more detail below). In such aspects, the CSI report request may sometimes be referred to as an AP CSI report request. In some aspects, the CSI report request may indicate one or more CSI-RSs to be measured by the UE 502. For example, as shown in FIG. 5, the CSI report request may indicate that the UE 502 is to measure a CSI-RS indexed as CSI-RS X, and/or that the UE 502 is to report measurements associated with CSI-RS X using one or more aperiodic CSI reports. Additionally, or alternatively, in some aspects, the CSI report request may indicate an ID associated with the final CSI report configuration described above in connection with reference number 520. For example, the CSI report request may indicate a CSI report configuration ID (e.g., reportConfigID) to be used by the UE 502 to prepare the one or more CSI reports (e.g., the one or more aperiodic CSI reports).

As indicated by reference number 540, based at least in part on receiving the CSI report request, the first RAN node 503-1 may schedule resources associated with a PUSCH to be used by the UE 502 to transmit the one or more CSI reports to the first RAN node 503-1. For example, in some aspects, the first RAN node 503-1 may schedule PUSCH resources that occur at a time interval (e.g., a slot) indexed as n + k, where n corresponds to a time interval associated with a PUCCH that contains a communication scheduling the PUSCH resources (described in more detail below in connection with reference number 545) and where k corresponds to a quantity of time intervals offset from the PUCCH that includes the PUSCH resources to be used by the UE 502 to transmit the one or more CSI reports to the first RAN node 503-1.

As indicated by reference number 545, the first RAN node 503-1 may transmit, and the UE 502 may receive, a scheduling message associated with the CSI report request (e.g., a message used to schedule PUSCH resources for transmitting one or more aperiodic CSI reports, among other examples). For example, the first RAN node 503-1 may transmit, and the UE 502 may receive, a DCI message that indicates that the UE 502 is to provide one or more CSI reports and/or that indicates uplink resources (e.g., PUSCH resources) to be used by the UE 502 to transmit the one or more CSI reports. In that regard, the scheduling message may include an indication of a CSI-RS associated with the CSI report (e.g., an indication that the UE 502 is to measure CSI-RS X), an indication of resources associated with transmitting the CSI report (e.g., an indication of the PUSCH resources located in time interval n + k), and/or an indication of the CSI report configuration associated with the CSI report (e.g., reportConfigID), among other information.

As indicated by reference number 550, the UE 502 may transmit, and the first RAN node 503-1 may receive, the one or more CSI reports requested by the second RAN node 503-2. For example, the UE 502 may perform one or more measurements associated with CSI-RS X, may compile one or more CSI reports including measurement results associated with CSI-RS X, and/or maytransmit the one or more CSI reports to the first RAN node 503-1 using the PUSCH resources indicated by the scheduling message (e.g., the PUSCH resources located in the time interval n + k). As indicated by reference number 555, the first RAN node 503-1 may extract the one or more CSI reports, and/or the first RAN node 503-1 may forward the one or more CSI reports to the second RAN node 503-2, as indicated by reference number 560. More particularly, the first RAN node 503-1 may transmit (e.g., using a D2 interface, such as a D2-U interface), and the second RAN node 503-2 may receive, a CSI report response including the one or more CSI reports. In some other aspects, such as aspects in which the first RAN node 503-1 did not successfully receive the one or more CSI reports (e.g., due to the inability of the first RAN node 503-1 to schedule uplink resources for transmission of the one or more CSI reports by the UE 502 and/or the unavailability of the UE 502 to perform the CSI reporting, among other examples), the CSI report response shown in connection with reference number 560 may indicate a failure cause associated with the CSI report request (e.g., the CSI report response may include a failure cause value associated with the CSI report request described above in connection with reference number 535, with the failure cause value being a codepoint or similar indicator used to indicate a specific failure cause associated with the CSI report request).

As described above in connection with reference number 515, in some aspects, the second RAN node 503-2 may be associated with an expected delay tolerance, which may be a period of time between transmission of a CSI report request and reception of the corresponding CSI report in which the CSI report is expected by the second RAN node 503-2. In such aspects, if the CSI report is not received by the second RAN node 503-2 within the delay tolerance, the second RAN node 503-2 may determine a failure status associated with the CSI report request (e.g., a timeout failure status). In this regard, and as indicated by reference number 565, in some aspects the second RAN node 503-2 may initiate a timer based at least in part on issuing the CSI report request, and, if no response is received from the first RAN node 503-1 before timer expiry, the second RAN node 503-2 may determine a failure status corresponding to the CSI report request (e.g., with a failure cause value associated with “timeout”). Put another way, in some aspects, and as indicated by reference number 565, the second RAN node 503-2 may initiate a timer based at least in part on transmitting the CSI report request (e.g., the CSI report request described above in connection with reference number 535), and/or the second RAN node 503-2 may identify that a failure condition has occurred based at least in part on the timer expiring prior to receiving a CSI report response (e.g., the CSI report described above in connection with reference number 560).

Based at least in part on first RAN node 503-1 and the second RAN node 503-2 signaling (e.g., using the D2-C interface) CSI configuration parameters associated with a CSI report to be provided to the second RAN node 503-2 by the UE 502, the first RAN node 503-1, the second RAN node 503-2, the CU 504, and/or the UE 502 may conserve computing, power, network, and/or communication resources that may have otherwise been consumed by CA operations in the absence of CSI reporting to the second RAN node 503-2 by the UE 502. For example, based at least in part on the first RAN node 503-1 and the second RAN node 503-2 signaling CSI configuration parameters associated with a CSI report to be provided to the second RAN node 503-2 by the UE 502, the UE 502 and the second RAN node 503-2 may communicate with an improved communication channel and thus a reduced error rate, which may conserve computing, power, network, and/or communication resources that may have otherwise been consumed to detect and/or correct communication errors.

As indicated above, FIG. 5 is provided as an example. Other examples may differ from what is described with respect to FIG. 5.

FIG. 6 is a diagram illustrating an example process 600 performed, for example, at a first RAN node or an apparatus of a first RAN node, in accordance with the present disclosure. Example process 600 is an example where the apparatus or the first RAN node (e.g., first RAN node 503-1) performs operations associated with CSI-RS configuration signaling between RAN nodes.

As shown in FIG. 6, in some aspects, process 600 may include receiving, from a second RAN node, a CSI-RS configuration message associated with a CSI report to be provided to the second RAN node by a UE (block 610). For example, the first RAN node (e.g., using reception component 802 and/or communication manager 806, depicted in FIG. 8) may receive, from a second RAN node, a CSI-RS configuration message associated with a CSI report to be provided to the second RAN node by a UE, as described above.

As further shown in FIG. 6, in some aspects, process 600 may include transmitting, to the second RAN node and based at least in part on receiving the CSI-RS configuration message, a CSI-RS configuration confirmation message (block 620). For example, the first RAN node (e.g., using transmission component 804 and/or communication manager 806, depicted in FIG. 8) may transmit, to the second RAN node and based at least in part on receiving the CSI-RS configuration message, a CSI-RS configuration confirmation message, as described above.

Process 600 may include additional aspects, such as any single aspect or any combination of aspects described below and/or in connection with one or more other processes described elsewhere herein.

In a first aspect, the CSI report is an aperiodic CSI report.

In a second aspect, alone or in combination with the first aspect, the CSI-RS configuration message indicates at least one of a CSI-RS resource configuration, an expected CSI report configuration, or an expected delay tolerance associated with the CSI report.

In a third aspect, alone or in combination with one or more of the first and second aspects, process 600 includes transmitting, to the second RAN node, a CSI-RS configuration request message, wherein receiving the CSI-RS configuration message includes receiving the CSI-RS configuration message in response to transmitting the CSI-RS configuration request message.

In a fourth aspect, alone or in combination with one or more of the first through third aspects, the CSI-RS configuration confirmation message indicates a CSI report configuration.

In a fifth aspect, alone or in combination with one or more of the first through fourth aspects, process 600 includes receiving, from the second RAN node, a CSI report request associated with the UE.

In a sixth aspect, alone or in combination with one or more of the first through fifth aspects, the CSI report request indicates an identifier associated with the CSI report configuration.

In a seventh aspect, alone or in combination with one or more of the first through sixth aspects, process 600 includes transmitting, to the UE and based at least in part on receiving the CSI report request, a scheduling message associated with the CSI report request, wherein the scheduling message includes at least one of an indication of a CSI-RS associated with the CSI report, or an indication of resources associated with transmitting the CSI report.

In an eighth aspect, alone or in combination with one or more of the first through seventh aspects, process 600 includes transmitting, to the second RAN node and based at least in part on receiving the CSI report request, a CSI report response, wherein the CSI report response includes at least one of an indication of a failure cause associated with the CSI report request, or the CSI report.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a second RAN node or an apparatus of a second RAN node, in accordance with the present disclosure. Example process 700 is an example where the apparatus or the second RAN node (e.g., second RAN node 503-2) performs operations associated with CSI-RS configuration signaling between RAN nodes.

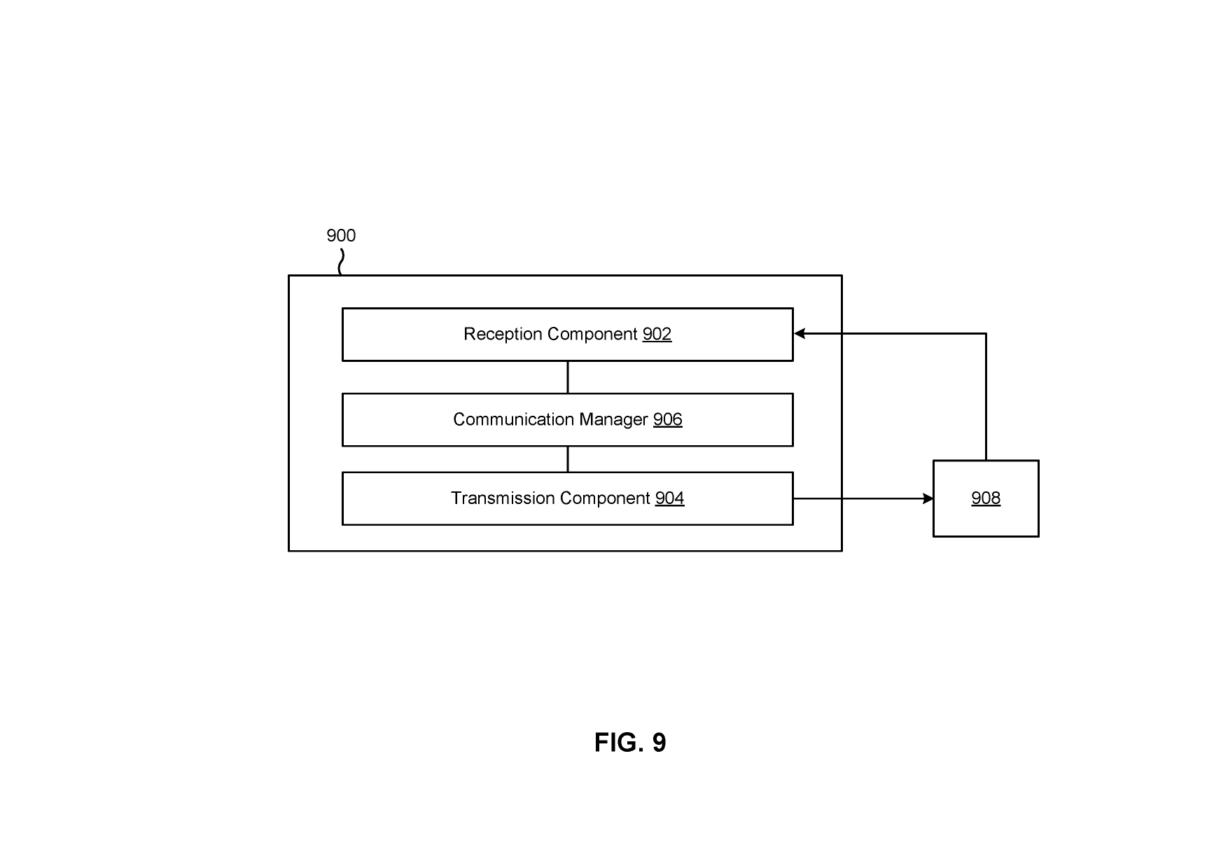

As shown in FIG. 7, in some aspects, process 700 may include transmitting, to a first RAN node, a CSI-RS configuration message associated with a CSI report to be provided to the second RAN node by a UE (block 710). For example, the second RAN node (e.g., using transmission component 904 and/or communication manager 906, depicted in FIG. 9) may transmit, to a first RAN node, a CSI-RS configuration message associated with a CSI report to be provided to the second RAN node by a UE, as described above.

As further shown in FIG. 7, in some aspects, process 700 may include receiving, from the first RAN node and based at least in part on receiving the CSI-RS configuration message, a CSI-RS configuration confirmation message (block 720). For example, the second RAN node (e.g., using reception component 902 and/or communication manager 906, depicted in FIG. 9) may receive, from the first RAN node and based at least in part on receiving the CSI-RS configuration message, a CSI-RS configuration confirmation message, as described above.

Process 700 may include additional aspects, such as any single aspect or any combination of aspects described below and/or in connection with one or more other processes described elsewhere herein.

In a first aspect, the CSI report is an aperiodic CSI report.

In a second aspect, alone or in combination with the first aspect, the CSI-RS configuration message indicates at least one of a CSI-RS resource configuration, an expected CSI report configuration, or an expected delay tolerance associated with the CSI report.

In a third aspect, alone or in combination with one or more of the first and second aspects, process 700 includes receiving, from the first RAN node, a CSI-RS configuration request message, wherein transmitting the CSI-RS configuration message includes transmitting the CSI-RS configuration message in response to receiving the CSI-RS configuration request message.

In a fourth aspect, alone or in combination with one or more of the first through third aspects, the CSI-RS configuration confirmation message indicates a CSI report configuration.

In a fifth aspect, alone or in combination with one or more of the first through fourth aspects, process 700 includes transmitting, to the first RAN node, a CSI report request associated with the UE.

In a sixth aspect, alone or in combination with one or more of the first through fifth aspects, the CSI report request indicates an identifier associated with the CSI report configuration.

In a seventh aspect, alone or in combination with one or more of the first through sixth aspects, process 700 includes initiating a timer based at least in part on transmitting the CSI report request, and identifying that a failure condition has occurred based at least in part on the timer expiring prior to receiving a CSI report response.

In an eighth aspect, alone or in combination with one or more of the first through seventh aspects, process 700 includes receiving, from the first RAN node and based at least in part on transmitting the CSI report request, a CSI report response, wherein the CSI report response includes at least one of an indication of a failure cause associated with the CSI report request, or the CSI report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a first RAN node, or a first RAN node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the first RAN node.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node 110 described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node 110 described above in connection with FIG. 1, such as a radio, one or more RF chains, one or more transceivers, or one or more modems, each of which may in turn be coupled with one or more antennas of the first RAN node.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node 110 described above in connection with FIG. 1, such as a radio, one or more RF chains, one or more transceivers, or one or more modems, each of which may in turn be coupled with one or more antennas of the first RAN node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a second RAN node, a CSI-RS configuration message associated with a CSI report to be provided to the second RAN node by a UE. The transmission component 804 may transmit, to the second RAN node and based at least in part on receiving the CSI-RS configuration message, a CSI-RS configuration confirmation message.

The transmission component 804 may transmit, to the second RAN node, a CSI-RS configuration request message, wherein receiving the CSI-RS configuration message includes receiving the CSI-RS configuration message in response to transmitting the CSI-RS configuration request message.

The reception component 802 may receive, from the second RAN node, a CSI report request associated with the UE.

The transmission component 804 may transmit, to the UE and based at least in part on receiving the CSI report request, a scheduling message associated with the CSI report request, wherein the scheduling message includes at least one of an indication of a CSI-RS associated with the CSI report, or an indication of resources associated with transmitting the CSI report.

The transmission component 804 may transmit, to the second RAN node and based at least in part on receiving the CSI report request, a CSI report response, wherein the CSI report response includes at least one of an indication of a failure cause associated with the CSI report request, or the CSI report.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a second RAN node, or a second RAN node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the second RAN node.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node 110 described above in connection with FIG. 1, such as a radio, one or more RF chains, one or more transceivers, or one or more modems, each of which may in turn be coupled with one or more antennas of the second RAN node.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node 110 described above in connection with FIG. 1, such as a radio, one or more RF chains, one or more transceivers, or one or more modems, each of which may in turn be coupled with one or more antennas of the second RAN node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a first RAN node, a CSI-RS configuration message associated with a CSI report to be provided to the second RAN node by a UE. The reception component 902 may receive, from the first RAN node and based at least in part on receiving the CSI-RS configuration message, a CSI-RS configuration confirmation message.

The reception component 902 may receive, from the first RAN node, a CSI-RS configuration request message, wherein transmitting the CSI-RS configuration message includes transmitting the CSI-RS configuration message in response to receiving the CSI-RS configuration request message.

The transmission component 904 may transmit, to the first RAN node, a CSI report request associated with the UE.

The communication manager 906 may initiate a timer based at least in part on transmitting the CSI report request.

The communication manager 906 may identify that a failure condition has occurred based at least in part on the timer expiring prior to receiving a CSI report response.

The reception component 902 may receive, from the first RAN node and based at least in part on transmitting the CSI report request, a CSI report response, wherein the CSI report response includes at least one of an indication of a failure cause associated with the CSI report request, or the CSI report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first radio access network (RAN) node, comprising: receiving, from a second RAN node, a channel state information reference signal (CSI-RS) configuration message associated with a CSI report to be provided to the second RAN node by a user equipment (UE); and transmitting, to the second RAN node and based at least in part on receiving the CSI-RS configuration message, a CSI-RS configuration confirmation message.

Aspect 2: The method of Aspect 1, wherein the CSI report is an aperiodic CSI report.

Aspect 3: The method of any of Aspects 1-2, wherein the CSI-RS configuration message indicates at least one of: a CSI-RS resource configuration, an expected CSI report configuration, or an expected delay tolerance associated with the CSI report.

Aspect 4: The method of any of Aspects 1-3, further comprising transmitting, to the second RAN node, a CSI-RS configuration request message, wherein receiving the CSI-RS configuration message includes receiving the CSI-RS configuration message in response to transmitting the CSI-RS configuration request message.

Aspect 5: The method of any of Aspects 1-4, wherein the CSI-RS configuration confirmation message indicates a CSI report configuration.

Aspect 6: The method of Aspect 5, further comprising receiving, from the second RAN node, a CSI report request associated with the UE.

Aspect 7: The method of Aspect 6, wherein the CSI report request indicates an identifier associated with the CSI report configuration.

Aspect 8: The method of Aspect 6, further comprising transmitting, to the UE and based at least in part on receiving the CSI report request, a scheduling message associated with the CSI report request, wherein the scheduling message includes at least one of: an indication of a CSI-RS associated with the CSI report, or an indication of resources associated with transmitting the CSI report.

Aspect 9: The method of Aspect 6, further comprising transmitting, to the second RAN node and based at least in part on receiving the CSI report request, a CSI report response, wherein the CSI report response includes at least one of: an indication of a failure cause associated with the CSI report request, or the CSI report.

Aspect 10: A method of wireless communication performed by a second radio access network (RAN) node, comprising: transmitting, to a first RAN node, a channel state information reference signal (CSI-RS) configuration message associated with a CSI report to be provided to the second RAN node by a user equipment (UE); and receiving, from the first RAN node and based at least in part on receiving the CSI-RS configuration message, a CSI-RS configuration confirmation message.

Aspect 11: The method of Aspect 10, wherein the CSI report is an aperiodic CSI report.

Aspect 12: The method of any of Aspects 10-11, wherein the CSI-RS configuration message indicates at least one of: a CSI-RS resource configuration, an expected CSI report configuration, or an expected delay tolerance associated with the CSI report.

Aspect 13: The method of any of Aspects 10-12, further comprising receiving, from the first RAN node, a CSI-RS configuration request message, wherein transmitting the CSI-RS configuration message includes transmitting the CSI-RS configuration message in response to receiving the CSI-RS configuration request message.

Aspect 14: The method of any of Aspects 10-13, wherein the CSI-RS configuration confirmation message indicates a CSI report configuration.

Aspect 15: The method of Aspect 14, further comprising transmitting, to the first RAN node, a CSI report request associated with the UE.

Aspect 16: The method of Aspect 15, wherein the CSI report request indicates an identifier associated with the CSI report configuration.

Aspect 17: The method of Aspect 15, further comprising: initiating a timer based at least in part on transmitting the CSI report request; and identifying that a failure condition has occurred based at least in part on the timer expiring prior to receiving a CSI report response.

Aspect 18: The method of Aspect 15, further comprising receiving, from the first RAN node and based at least in part on transmitting the CSI report request, a CSI report response, wherein the CSI report response includes at least one of: an indication of a failure cause associated with the CSI report request, or the CSI report.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first radio access network (RAN) node for wireless communication, comprising:
one or more memories; and
one or more processors, coupled to the one or more memories, configured to cause the first RAN node to:
receive, from a second RAN node, a channel state information reference signal (CSI-RS) configuration message associated with a CSI report to be provided to the second RAN node by a user equipment (UE); and
transmit, to the second RAN node and based at least in part on receiving the CSI-RS configuration message, a CSI-RS configuration confirmation message.

2. The first RAN node of claim 1, wherein the CSI report is an aperiodic CSI report.

3. The first RAN node of claim 1, wherein the CSI-RS configuration message indicates at least one of:
a CSI-RS resource configuration,
an expected CSI report configuration, or
an expected delay tolerance associated with the CSI report.

4. The first RAN node of claim 1, wherein the one or more processors are further configured to cause the first RAN node to transmit, to the second RAN node, a CSI-RS configuration request message,
wherein the one or more processors, to cause the first RAN node to receive the CSI-RS configuration message, are configured to cause the first RAN node to receive the CSI-RS configuration message in response to transmitting the CSI-RS configuration request message.

5. The first RAN node of claim 1, wherein the CSI-RS configuration confirmation message indicates a CSI report configuration.

6. The first RAN node of claim 5, wherein the one or more processors are further configured to cause the first RAN node to receive, from the second RAN node, a CSI report request associated with the UE.

7. The first RAN node of claim 6, wherein the CSI report request indicates an identifier associated with the CSI report configuration.

8. The first RAN node of claim 6, wherein the one or more processors are further configured to cause the first RAN node to transmit, to the UE and based at least in part on receiving the CSI report request, a scheduling message associated with the CSI report request, wherein the scheduling message includes at least one of:
an indication of a CSI-RS associated with the CSI report, or
an indication of resources associated with transmitting the CSI report.

9. The first RAN node of claim 6, wherein the one or more processors are further configured to cause the first RAN node to transmit, to the second RAN node and based at least in part on receiving the CSI report request, a CSI report response, wherein the CSI report response includes at least one of:
an indication of a failure cause associated with the CSI report request, or
the CSI report.

10. A second radio access network (RAN) node for wireless communication, comprising:
one or more memories; and
one or more processors, coupled to the one or more memories, configured to cause the second RAN node to:
transmit, to a first RAN node, a channel state information reference signal (CSI-RS) configuration message associated with a CSI report to be provided to the second RAN node by a user equipment (UE); and
receive, from the first RAN node and based at least in part on receiving the CSI-RS configuration message, a CSI-RS configuration confirmation message.

11. The second RAN node of claim 10, wherein the CSI report is an aperiodic CSI report.

12. The second RAN node of claim 10, wherein the CSI-RS configuration message indicates at least one of:
a CSI-RS resource configuration,
an expected CSI report configuration, or
an expected delay tolerance associated with the CSI report.

13. The second RAN node of claim 10, wherein the one or more processors are further configured to cause the RAN to receive, from the first RAN node, a CSI-RS configuration request message,
wherein the one or more processors, to cause the second RAN node to transmit the CSI-RS configuration message, are configured to cause the second RAN node to transmit the CSI-RS configuration message in response to receiving the CSI-RS configuration request message.

14. The second RAN node of claim 10, wherein the CSI-RS configuration confirmation message indicates a CSI report configuration.

15. The second RAN node of claim 14, wherein the one or more processors are further configured to cause the second RAN node to transmit, to the first RAN node, a CSI report request associated with the UE.

16. The second RAN node of claim 15, wherein the CSI report request indicates an identifier associated with the CSI report configuration.

17. The second RAN node of claim 15, wherein the one or more processors are further configured to cause the second RAN node to:
initiate a timer based at least in part on transmitting the CSI report request; and
identify that a failure condition has occurred based at least in part on the timer expiring prior to receiving a CSI report response.

18. The second RAN node of claim 15, wherein the one or more processors are further configured to cause the second RAN node to receive, from the first RAN node and based at least in part on transmitting the CSI report request, a CSI report response, wherein the CSI report response includes at least one of:
an indication of a failure cause associated with the CSI report request, or
the CSI report.

19. A method of wireless communication performed by a first radio access network (RAN) node, comprising:
receiving, from a second RAN node, a channel state information reference signal (CSI-RS) configuration message associated with a CSI report to be provided to the second RAN node by a user equipment (UE); and
transmitting, to the second RAN node and based at least in part on receiving the CSI-RS configuration message, a CSI-RS configuration confirmation message.

20. The method of claim 19, wherein the CSI-RS configuration message indicates at least one of:
a CSI-RS resource configuration,
an expected CSI report configuration, or
an expected delay tolerance associated with the CSI report.
